(19) United States
(12) Patent Application Publication
(10) Pub. No.: US 2019/0240786 A1
(43) Pub. Date: Aug. 8, 2019

(54) METHODS FOR CUTTING A WORKPIECE USING A LASER BEAM

(71) Applicant: TRUMPF Werkzeugmaschinen GmbH + Co. KG, Ditzingen (DE)

(72) Inventors: Patrick Mach, Weinstadt (DE); Michael Krutzke, Sindelfingen (DE); Wolf Wadehn, Newington, CT (US); Yannic Burde, Rutesheim (DE); Christoph Kraus, Renningen (DE); Julian Weeber, Beilstein (DE)

(21) Appl. No.: 16/388,269

(22) Filed: Apr. 18, 2019

Related U.S. Application Data
(63) Continuation of application No. PCT/EP2017/076923, filed on Oct. 20, 2017.

(30) Foreign Application Priority Data
Oct. 24, 2016 (DE) 102016220807.1

(51) Int. Cl. B23K 26/38; B23K 26/14; B23K 26/04

(52) U.S. Cl. CPC B23K 26/38; B23K 26/048; B23K 26/1464

(57) ABSTRACT

Method for cutting a planar and/or metal workpiece along a predefined cutting contour using a laser beam and a cutting gas emitted from a nozzle, wherein the laser beam makes a recess in the workpiece so as to form a recess hole (on the cutting contour or at least partly close to the cutting contour. At least two machining parameters are continuously modified during formation of the recess hole, and/or at least one machining parameter is continuously modified on a switch path between the recess hole and an endpoint lying on the cutting contour.

### CROSS REFERENCE TO RELATED APPLICATIONS

This application is a continuation of and claims priority under 35 U.S.C. § 120 from PCT Application No. PCT/EP2017/076923, filed on Oct. 20, 2017, which claims priority from German Application No. 10 2016 220 807.1, filed on Oct. 24, 2016. The entire contents of each of these priority applications are incorporated herein by reference.

### TECHNICAL FIELD

A method for cutting a plate-like and/or metal workpiece along a predetermined cutting contour using a laser beam.

### BACKGROUND

In previously conventional methods for laser cutting of, for example, plate-like workpieces, after the penetration of the laser beam into the workpiece a start-up path that precedes the actual cutting contour is required. It is required since, during the penetration, a material throw-up is produced around the penetration hole. In addition, the cutting contour would be damaged if penetration were carried out directly thereon. Furthermore, at the latest at the beginning of the actual cut along the cutting contour cutting parameters that are required in each case have to be adjusted. Cutting parameters are, for example, the spacing of the nozzle from the workpiece, focal position of the laser, etc.

A generic method is disclosed in U.S. Pat. No. 5,770,833 A1. A method for penetrating a laser beam into a workpiece is described, in which the penetration is begun slightly beside the actual penetration hole and, during travel to the penetration hole, the spacing between the nozzle and workpiece is continuously decreased.

From JPH 07195186 A and US 2007/170157 A1 it is further known, to cut pointed corners, to continuously change cutting parameters before and after a corner of the cutting contour.

U.S. Pat. No. 5,444,211 A discloses that two different points A and B of the workpiece surface are reached to switch or change cutting parameters.

JP 60240393 A discloses directing a laser beam onto a workpiece and heating the material of the workpiece up close to its melting temperature. A nozzle is then moved in the direction of the workpiece, whereby a penetration is carried out.

As a result of the start-up path, the laser cutting time of workpieces or components sometimes increases by up to 20%.

### SUMMARY

Advantages include a method that increases process speed during laser cutting of a workpiece. A method for cutting a plate-like and/or metal workpiece along a predetermined cutting contour using a laser beam and a cutting gas that is discharged from a nozzle, wherein the laser beam penetrates into the workpiece to form a penetration hole on the cutting contour or at least partially beside the cutting contour, wherein, during the formation of the penetration hole, at least two processing parameters and/or, on a switching path that is located from the penetration hole or from a starting point that is located between the penetration hole and the cutting contour and an end point located on the cutting contour, at least one processing parameter is/are continuously changed.

When moving into the actual cutting contour, there is no “hard” switching between different parameter values of a processing parameter. A “hard” conversion of the processing parameter at a starting point of the actual cutting contour or at the end of the formation of the penetration hole can be prevented. Instead, processing parameters during the penetration and/or on the switching path are continuously changed. Consequently, the time that is generally required to switch the processing parameters between penetration parameter values and cutting parameter values can be used productively, whereas in the prior art during this time, for example, a cutting head or the laser beam of the laser cutting machine is idle.

The switching path can begin directly at the penetration hole, but alternatively it can also begin spaced apart from the penetration hole. The switching path can further extend into the cutting contour so that the spacing of the penetration hole from the cutting contour can be kept small.

There can be provision to select penetration parameter values that produce the smallest possible material throw-up during the penetration operation around the penetration hole. The penetration can be carried out with no material throw-up. It is thus possible to prevent, for example, melt splashes from solidifying on the surface of the workpiece, e.g., in regions of a useful portion that is intended to be produced. In the case of penetration with no material throw-up, the penetration hole does not have to be spaced apart from the cutting contour, but instead can be located on the cutting contour.

For example, the penetration can be carried out by a partial penetration first being carried out, then a material throw-up that occurs being blown away, typically using the cutting gas, and subsequently complete penetration in the penetration hole that is intended to be formed.

The processing parameter can be selected from the group focal position, focal diameter, spacing of the nozzle/workpiece, gas pressure including cutting gas pressure and/or transverse blowing pressure, laser power, and cutting speed. This group of cutting parameters forms an important set of processing parameters that are intended to be adjusted at the beginning of a cutting process (cutting parameters).

In some embodiments, there can be provision for the processing parameters to be changed in a linear manner. For example, the spacing of the nozzle/workpiece can be linearly changed in a simple manner by the nozzle or the cutting head on which the nozzle is arranged being moved towards the workpiece at a constant speed.

In some embodiments, there can be provision for the spacing of the nozzle/workpiece to be decreased during the penetration and/or on the switching path. That is to say, there can be provision for the nozzle to be moved towards the workpiece during the penetration and/or on the switching path. By decreasing the spacing between the nozzle and workpiece, the cutting gas can be introduced into the cutting gap in an improved manner.

There can also be provision for the cutting speed on the switching path to be increased. Consequently, the switching path can already be used to accelerate the cutting speed, for example, to an end speed that is desired during the actual cutting process. Furthermore, there can be provision for the focal position of the laser beam during the penetration or on the switching path to be adjusted relative to the nozzle in the direction of the workpiece, with a vertically orientated laser beam, consequently in a downward direction. By changing the focal position, both a focal drift, for example, as a result of heating optical elements in the cutting head, can be compensated for and the formation of the cutting gap, typically from the penetration hole, can be improved. A tearing of the cut can be prevented.

There can also be provision for the laser power and/or the pressure of the cutting gas to be increased during the penetration and/or on the switching path. In this manner, it is possible to prevent at the beginning of the penetration operation, as a result of an excessively high laser power and/or as a result of the gas pressure, splashes being thrown in the direction of the optical processing unit. During the penetration and/or on the switching path, the laser power and/or the gas pressure can be increased to a value that is suitable for the cutting process.

The processing parameters of spacing of the nozzle/workpiece, focal position, focal diameter, laser power, gas pressure and/or cutting speed during the penetration or on a path of approximately 5 mm can be synchronously adapted. Thus, the cutting speed can after the penetration within a distance of 5 mm be increased to the desired cutting speed end value, the spacing of the nozzle/workpiece can be continuously reduced and the focal position can be reduced to the end values desired in each case, and the gas pressure and laser power can be increased. After the end values are reached, the cutting of the cutting contour can be finished with these cutting parameters. In alternative variants of the method, individual processing parameters, such as, for example, the gas pressure, are not continuously changed, but instead can be discretely switched at the end of the penetration operation or at the beginning or at the end of the switching path. There can also be provision for specific processing parameters to be changed during the formation of the penetration hole and others on the switching path.

During a penetration process that is not completely free from throw-up, the spacing of the penetration hole with respect to the cutting contour can be substantially correspond to a cutting gap width. Generally, the penetration can be carried out with a small spacing relative to the cutting contour, such as in the remaining grid that is adjacent to the cutting contour or in an off-cut, that is to say, the waste or scrap region of the workpiece.

If the width of the spacing relative to the cutting contour substantially corresponds to a cutting gap width, it is possible to prevent, as a result of the diameter of the penetration hole, the cutting contour from becoming damaged along the useful portion that is adjacent to the remaining grid or on the useful portion. For example, the penetration can be carried out less than 1 mm, e.g., approximately 0.4 mm, beside the cutting contour.

In some embodiments, after the penetration and before the start-up from the penetration hole, processing parameters can be changed. For example, the spacing of the nozzle/workpiece increased and the focal position of the workpiece adjusted in the direction of the nozzle, that is to say, with a vertically orientated laser beam, in an upward direction.

It is consequently possible to proceed with multiple steps. Firstly, it is possible to penetrate into the workpiece with a small spacing, for example, approximately corresponding to a cutting gap width, with respect to the actual cutting contour. The penetration can be carried out in this instance with little material throw-up. In a next step, a larger nozzle spacing and a higher focal position with a fixed cutting head, typically with the laser beam switched off, can be adjusted as start-up parameters, and the gas pressure of the cutting gas can be increased. Subsequently, the laser beam can then be switched on and moved or directed at a low speed from the penetration hole into the cutting contour. Subsequently, the respective desired end values (cutting values) of the processing parameters can then be adjusted in a linear manner, by which end values it is then possible to cut along the remaining cutting contour.

As a result of the penetration carried out directly beside the useful portion cutting contour and the omission of an extensive start-up path, the laser cutting time of the useful portions can be reduced, sometimes even by up to 20%. In addition, a plurality of useful portions that are intended to be produced can be arranged closer together on a workpiece board, whereby a considerable saving of material can be achieved.

Other features and advantages of the invention will be appreciated from the following detailed description of a laser cutting machine that is suitable for carrying out the method with reference to the drawings that show details that are significant to the invention, and from the claims. The individual features can be implemented individually per se or together in any combinations in variants of the invention.

### DESCRIPTION OF DRAWINGS

FIG. 1 shows a laser cutting machine.

FIG. 2 is a plan view of a workpiece that is intended to be cut with a cutting contour and penetration hole.

FIG. 3 is a schematic illustration of a beam path with penetration hole and switching path.

FIG. 4 is a schematic illustration of laser cutting methods.

### DETAILED DESCRIPTION

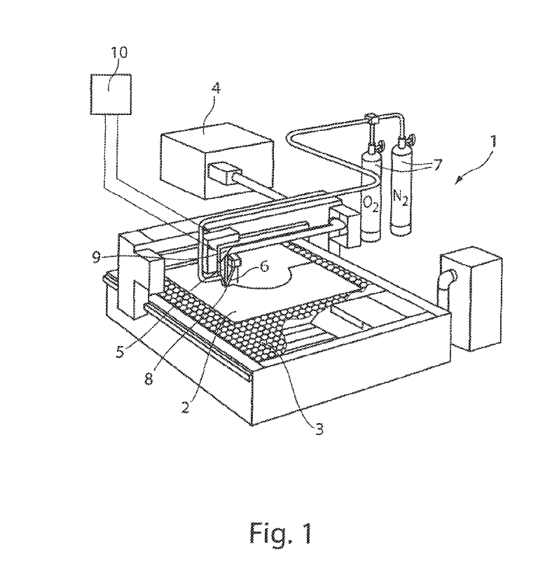

FIG. 1 shows a laser cutting machine 1 for laser cutting a workpiece 2 that is arranged on a workpiece support 3. The laser cutting machine 1 has a laser beam generator 4 that in this example is constructed as a diode laser. In alternative embodiments, there is provision for the laser beam generator 4 to be constructed as a CO₂ laser or solid-state laser. Furthermore, a cutting head 5 can be seen in FIG. 1. In the laser beam generator 4, there is produced a laser beam 6 that by light conduction or redirection mirrors is guided from the laser beam generator 4 to the cutting head 5. The laser beam 6 is directed by an optical focusing unit that is arranged in the cutting head 5 onto the workpiece 2. The laser cutting machine 1 is further supplied with cutting gases 7, e.g., oxygen and nitrogen. The cutting gases 7 reach a nozzle (cutting gas nozzle) 8 of the cutting head 5 from which they are discharged together with the laser beam 6. The laser cutting machine 1 further includes optical elements, for example, adaptive optical units 9 or a plurality of lenses of an optical zoom unit by which the focal position and focal diameter of the laser beam 6 can be varied or adjusted. Furthermore, the laser cutting machine 1 has a machine control 10. The machine control 10 is configured to move both the cutting head 5 together with the cutting gas nozzle 8 relative to the workpiece 2 and to control the optical unit 9. Consequently, the machine control 10 is configured to control processing parameters of the laser cutting machine 1, e.g., the focal position of the laser beam 6, spacing of the nozzle/workpiece and the cutting speed of the laser beam or movement speed and locations of the cutting head 5 and the intensity of the laser beam 6 and the gas pressure of the cutting gases 7.

The machine control 10, during the penetration of the laser beam 6 into the workpiece 2 and/or on a switching path, continuously changes at least one processing parameter. The switching path extends on the workpiece 2 that is intended to be cut between a penetration hole produced by the laser beam 6 and a location of the workpiece 2 located on a predetermined cutting contour.

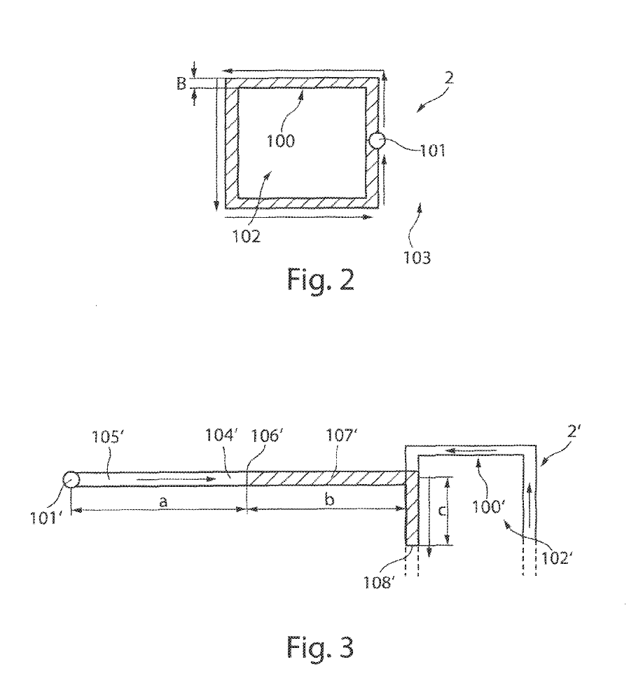

FIG. 2 is a plan view of the workpiece 2 of FIG. 1. Schematically illustrated is a cutting contour 100 along which the workpiece 2 is intended to be cut. Furthermore, a penetration hole 101 of the laser beam can be seen.

The cutting contour 100 surrounds a useful portion 102. The outer side of the contour 100 is adjoined by a remaining grid 103. The remaining grid 103 can be used as a waste region and/or —with greater spacing with respect to the cutting contour 100—to produce additional useful portions 102.

FIG. 2 shows that the penetration is carried out directly adjacent to the actual cutting contour 100. The penetration hole 101 is consequently located in the remaining grid 103, wherein the spacing of the penetration hole 101 with respect to the cutting contour 100 substantially corresponds to a cutting gap width B. Consequently, the penetration hole 101 does not reach the side of the cutting contour 100 facing the useful portion 102. Effects of the penetration on the useful portion 102 are consequently minimized. In the case of a penetration without any throw-up and/or a focal diameter of the laser beam 6 that is significantly smaller than the cutting gap width B, the penetration hole 101 can also be arranged on or inside the cutting contour 100.

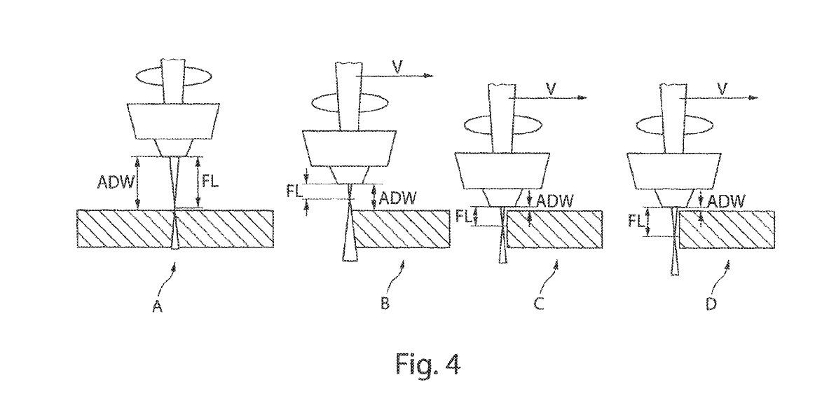

FIG. 3 shows a schematically enlarged path 104′ of a laser beam on a workpiece 2′. It is again possible to see a penetration hole 101′ from which the laser beam is guided along the path 104′. The laser first passes over a start-up path 105′, in this example having a length “a” of 0.2 mm. At the starting position 106′, a switching path 107′ begins. The switching path 107′ extends in this instance into a cutting contour 100′ as far as the end position 108′. The cutting contour 100′ adjoins a useful portion 102′, that is to say, the workpiece portion that is intended to be produced. Outside the cutting contour 100′, the length of the switching path b is in this example 0.2 mm. On the cutting contour 100′, the switching path has a length c of 4.8 mm. Cutting parameters, as will be explained in greater detail below with reference to FIG. 4, are continuously changed along the switching path 107′. FIG. 4 shows schematically four method steps A, B, C, D of a variant of the method. By way of example, it is assumed that the workpiece 2′ that is intended to be cut (FIG. 3) is formed from 8 mm thick high-grade steel and is intended to be cut on the laser cutting machine 1 of FIG. 1. The laser cutting machine 1 is in this example constructed as a 2D laser flat-bed machine and is operated using nitrogen as a cutting gas to carry out fusion cutting operations.

In the first method step A, a penetration is carried out without any throw-up with lateral spacing of a+b (FIG. 3) of 0.4 mm with respect to the desired useful portion cutting contour 100′ (FIG. 3). The vertical spacing of the cutting gas nozzle 8 with respect to the workpiece 2′, that is to say, the spacing of the nozzle/workpiece, ADW, is in this method step A in this example 10 mm. The focal position FL measured relative to the opening of the cutting gas nozzle 8 is in this example −10 mm. That is to say, the focal point of the laser beam 6 is located on the workpiece surface of the workpiece 2′. The gas pressure is 2 bar and the laser power is 1500 W (average power).

In the following method step B, a start-up is carried out from the penetration hole 101′ (FIG. 3). To this end, after the method step A is completed, the spacing of the nozzle/workpiece ADW is adjusted to 4 mm. The focal position FL is adjusted to −2.5 mm. Consequently, the focal position FL is above the workpiece 2, that is to say, between the cutting head 5 (FIG. 1) and the surface of the workpiece 2′. The gas pressure is increased to 18 bar. The cutting head 5 and the laser beam 6 (FIG. 1) are moved with these start-up parameters relative to the workpiece 2′ with an advance or cutting speed v of 1.8 m per minute along the start-up path 105′. For the start-up parameters, there are selected values that ensure a good beginning to the cut. Depending on the type and thickness of the material of the workpiece 2, however, the cutting process can also be begun with penetration parameters and the start-up path 105′ and the method step B can be omitted.

The subsequent method step C begins with the switching path 107′ (FIG. 3) being reached, that is to say, when the starting position 106′ is reached or—when the method step B is omitted—directly at the penetration hole 101′ (FIG. 3).

In the method variant illustrated here, the length b+c (FIG. 3) of the switching path 107′ is 5 mm in total.

While the laser beam 6 is moved along the switching path 107′, at least one processing parameter is continuously and linearly changed to such an extent that it reaches a desired end value (cutting parameter) for the cut along the cutting contour 100′. The spacing of the nozzle/workpiece ADW is reduced from 4 mm in a linear manner to 1 mm for better coupling of the cutting gas in the cutting gap. The focal position FL is also decreased in a linear manner from −2.5 mm to −6.5 mm to counteract in a compensating manner a thermally caused focal point displacement. The advance or cutting speed v is increased from 1.8 m per minute to 2.8 m per minute.

When the laser beam reaches the end of the switching path 107′ (FIG. 3), in other words if the laser beam reaches the end position 108′ (FIG. 3), all the processing parameter end values (cutting parameter values) that are desired for the cut along the cutting contour 100′ are achieved.

Consequently, in the last method step D a cut of the remaining cutting contour is carried out with processing parameters (cutting parameters) that are adjusted in accordance with the desired end values. In the method step D, the spacing of the nozzle/workpiece ADW is 1 mm, the focal position is −6.5 mm and the advance speed v is 2.8 m per minute with a cutting gas pressure of 18 bar.

Consequently, in the method step C, there is produced a continuous adaptation of the processing parameters along the switching path 107′. A stoppage of the processing head 5 when moving into the cutting contour 100, 100′ for discretely switching the processing parameters is omitted. In an advantageous method variant, the start-up path 105′ is also omitted, that is to say, after the processing head 5 has moved out of the penetration hole 101′, the continuous change of the processing parameters begins immediately. In this manner, the time period and path required to reach the final cutting parameters is minimized.

As a result of dense arrangement of the penetration hole 101′ on the cutting contour 100′, it is additionally possible to nest or arrange a plurality of useful portions 102′ more tightly on the original workpiece 2′, whereby an advantageous saving of material is produced.

In another alternative or additional method variant, the processing parameters are continuously changed during the method step A shown in FIG. 4.

For example, at the beginning of the penetration of the laser beam 6 in an aluminum workpiece 2 with a thickness of 8 mm, that is to say, at the beginning of the method step A, a vertical spacing of the cutting gas nozzle 8 with respect to the workpiece 2 (ADW) of 10 mm is adjusted. The focal position FL measured relative to the opening of the cutting gas nozzle 8 is in this example −10 mm. That is to say, the focal point of the laser beam 6 is on the workpiece surface of the workpiece 2′. The laser power is 3500 W (pulsed) and the cutting gas pressure is 0.6 bar. In addition, from a transverse blowing nozzle that is arranged on the cutting head 5 (not shown), another gas flow can be directed at an angle to the laser beam 6 onto the workpiece to protect the cutting head 5 from splashes and smoke.

During the formation of the penetration hole 101′ in method step A, the cutting head 5 is moved perpendicularly downwards until, at the end of the penetration, the spacing that is suitable for the subsequent cutting of the contour 100′ between the cutting gas nozzle 8 and the workpiece surface is achieved, typically between 0.2 mm and 5 mm. At the same time, the gas pressure of the cutting gas 7 is increased continuously to 10 bar, the focal point FL relative to the cutting gas nozzle 8 is raised and the laser power is increased to 8000 W (CW). At the end of the method step A, the additional gas flow is (discretely) switched off.

With the processing parameters that are achieved at the end of the method step A (cutting parameters), a penetration is made into the cutting contour 100′ over the shortest possible path. Alternatively, in the event of throw-up-free penetration and/or a focal diameter during the penetration that is smaller than the cutting gap width B, the penetration hole can be arranged on or inside the cutting contour 100′.

In a combination of the described methods, selected processing parameters and the same or other processing parameters on a switching path 107′ are continuously changed during the method step A. For example, the spacing ADW, the cutting gas pressure, and the focal position FL during the method step A of penetration are continuously changed. On the switching path 107′, there is then a continuous change of the laser power, the cutting speed v, the focal diameter and the focal position FL. With this method variant, the period of time and path required for the conversion of the penetration and cutting parameters can be minimized.

Depending on the type and thickness of the material of the workpiece that is intended to be cut, it can be necessary to provide a start-up path 105′ between the penetration hole 101′ and the switching path 107′. In this instance, there are achieved at the end of the method step A start-up parameters by which, in the method step B, the cutting process is begun. The subsequent method step C for changing the processing parameters until cutting parameter values are reached begins with reaching the switching path 107′ (FIG. 3), that is to say, when the starting position 106′ is reached.

It is thus possible, for example, at the beginning of the penetration operation for the spacing ADW between the cutting gas nozzle 8 and the workpiece surface to be 10 mm and the focal position FL relative to the opening of the cutting gas nozzle 8 to have a value of −10 mm. At the end of the method step A, the spacing ADW between the cutting gas nozzle 8 and workpiece surface is 4 mm, the focal position FL is −2.5 mm. On the start-up path, the cutting head is moved at a cutting speed of 1.8 m/min. On the switching path 107′, the spacing ADW between the cutting gas nozzle 8 and workpiece surface is reduced to 1 mm, the focal position FL is displaced from −2.5 mm to −6.5 mm and the cutting speed is increased to 2.8 m/min. At the latest at the end point 108′ of the switching path 107′, these cutting values of the processing parameters are achieved so that the cutting of the cutting contour 100, 100′ in the method step D can be carried out with these values.

### OTHER EMBODIMENTS

A number of embodiments of the invention have been described. Nevertheless, it will be understood that various modifications may be made without departing from the spirit and scope of the invention. Accordingly, other embodiments are within the scope of the following claims.

What is claimed is:

1. A method for cutting a workpiece along a predetermined cutting contour, the method comprising:
discharging a laser beam and a cutting gas from a nozzle;
directing the laser beam to penetrate into the workpiece to form a penetration hole on the cutting contour or at least partially beside the cutting contour; and
continuously changing at least two processing parameters during the formation of the penetration hole and/or continuously changing at least one processing parameter while forming a switching path between the penetration hole and an end point located on the cutting contour.

2. The method of claim 1, wherein the switching path extends into the cutting contour.

3. The method of claim 1, wherein the processing parameters are selected from a group including focal position, focal diameter, spacing between the nozzle and the workpiece, gas pressure, laser power, and cutting speed.

4. The method of claim 1, wherein the processing parameters are continuously changed in a linear manner.

5. The method of claim 1, comprising increasing a cutting speed while forming the switching path.

6. The method of claim 1, wherein a spacing between the nozzle and the workpiece is decreased during the formation of at least one of the penetration hole and the switching path.

7. The method of claim 1, wherein a focal position of the laser beam is adjusted relative to the nozzle in the direction towards the workpiece during the forming of the penetration hole or on the switching path.

8. The method of claim 1, wherein at least one of a laser power of the laser beam and a pressure of the cutting gas is increased during the formation of the penetration hole.

9. The method of claim 1, wherein at least one of a laser power of the laser beam and a pressure of the cutting gas is increased during the formation of the switching path.

10. The method of claim 1, wherein a spacing between the penetration hole and the cutting contour corresponds to a width of the laser beam.

11. The method of claim 1, wherein the penetration hole is on the cutting contour.

12. The method of claim 1, wherein, after the forming the penetration hole and before forming the switching path, a spacing between the nozzle and the workpiece is increased and a focal position of the laser beam is adjusted in the direction of the nozzle.
